(19) United States
(12) Patent Application Publication
(10) Pub. No.: US 2018/0363848 A1
(43) Pub. Date: Dec. 20, 2018

(54) Modular Membrane LNG Tank

(71) Applicant: Roald T. Lokken, Houston, TX (US)

(72) Inventor: Roald T. Lokken, Houston, TX (US)

(21) Appl. No.: 16/060,826

(22) PCT Filed: Oct. 28, 2016
(86) PCT No.: PCT/US2016/059425

§ 371 Date: Jun. 8, 2018

Related U.S. Application Data
(60) Provisional application No. 62/272,398, filed on Dec. 29, 2015.

(51) Int. Cl. F17C 1/00

(52) U.S. Cl. CPC F17C 1/002; F17C 2201/052; F17C 2203/0643; F17C 2270/0171; F17C 2203/0651; F17C 2205/0184; F17C 2270/0105; F17C 2203/0646

(57) ABSTRACT

A method, including: obtaining a stand-alone liquefied gas storage tank, wherein the liquefied gas storage tank includes a membrane insulation system; and disposing the liquefied gas storage tank onto a storage tank pre-installed foundation.

### CROSS-REFERENCE TO RELATED APPLICATION

This application claims the benefit of U.S. Provisional Patent Application 62/272,398, filed Dec. 29, 2015, entitled MODULAR MEMBRANE LNG TANK, the entirety of which is incorporated by reference herein.

### FIELD OF THE INVENTION

Exemplary embodiments described herein pertain to liquefied gas storage tanks, and more particularly to such tanks being configured for onshore use.

### BACKGROUND

This section is intended to introduce various aspects of the art, which may be associated with non-limiting examples of the present technological advancement. This discussion is believed to assist in providing a framework to facilitate a better understanding of particular aspects of the present technological advancement. Accordingly, it should be understood that this section should be read in this light, and not necessarily as admissions of prior art.

Onshore tanks for the storage of liquefied natural gas (LNG) are required at LNG liquefaction and regasification plants. A common LNG storage tank is the full-containment tank with a 9% nickel steel inner liner and a cast-in-place concrete outer tank. LNG is liquefied natural gas at substantially atmospheric pressure and about −162° C. (−260° F.) (see, for example, U.S. Pat. No. 8,603,375, the entirety of which is hereby incorporated by reference).

Another type of onshore tank for the storage of LNG is a membrane tank wherein a thin (e.g. 1.2 mm thick) metallic membrane is installed within a cylindrical concrete structure which, in turn, is built either below or above grade on land. A layer of insulation is typically interposed between the metallic membrane, e.g., of stainless steel, and the load bearing concrete cylindrical walls and flat floor (see, for example, U.S. Pat. Nos. 3,511,003, 4,225,054, 4,513,550, and 5,468,089, U.S. Patent Publication 2011/0168722, and French Patent 2,739,675, the entirety of each of which is hereby incorporated by reference).

These types of tanks are built on location, requiring that a large number of work hours are performed on site. This is not necessarily a problem for regasification plants as these facilities are typically built in locations and countries with existing infrastructure and labor markets. However, this can be problematic at liquefaction plants, which are in many cases built in remote locations with little infrastructure and non-existent labor markets. As a consequence, the cost to build LNG storage tanks at liquefaction plants can be high.

Membrane insulation systems are used in the tanks of ships that carry liquefied gases in bulk, such as LNG. Membrane insulation systems include a primary metallic membrane, a layer of insulation, a secondary membrane that provides containment of the LNG if the primary membrane were to leak, and another layer of insulation. The insulation layer can be connected to the inner steel hull of the LNG tank (see, for example, U.S. Pat. Nos. 7,540,395, 7,555,991, and 7,597,212, the entirety of each of which is hereby incorporated by reference).

Modular construction of tanks for storage of liquefied gases have been proposed, but still require significant construction on site because only discrete elements of the tanks are built in a fabrication yard, with most work being on site (see, for example, U.S. Pat. No. 6,729,492 and U.S. Patent Publication 2008/0314908, the entirety of each of which is hereby incorporated by reference).

Transportable, large-scale tanks have been proposed. These were not proposed for use as an onshore tank (see, for example, Korean patent document 2015 22439, which is hereby incorporated by reference in its entirety).

Additional background can also be found in Structural Capacities of LNG Membrane Containment Systems; 19th International Offshore and Polar Engineering Conferences (2009) (pp. 107-114), which is hereby incorporated by reference in its entirety.

### SUMMARY

A method, including: obtaining a stand-alone liquefied gas storage tank, wherein the liquefied gas storage tank includes a membrane insulation system; and disposing the liquefied gas storage tank onto a pre-installed foundation.

The method can further include transporting the liquefied gas storage tank using a heavy lift ship; transporting the liquefied gas storage tank using a land-based transportation system; and connecting the liquefied gas storage tank to piping, electrical, and control systems.

In the method, the pre-installed foundation can be a piled foundation.

In the method, the pre-installed foundation can be a slab foundation, a gravel pad, or concrete footings.

The method can further include: fabricating the liquefied gas storage tank in a drydock; floating the liquefied gas storage tank over a partially submerged heavy lift ship; and deballasting the heavy lift ship to transit draft.

The method can further include fabricating the liquefied gas storage tank on a quay and moving the liquefied gas storage tank onto a heavy ship.

The method can further include disposing base isolation devices between the foundation and the liquefied gas storage tank to minimize earthquake loads on the liquefied gas storage tank.

The method can further include creating a tank farm by disposing a plurality of stand-alone liquefied gas storage tanks at a liquefaction plant, regasification plant, or a peak-shaving plant.

The method can further include establishing a berm around the liquefied gas storage tank.

The method of can further include: positioning the liquefied gas storage tank using a multi-axle transporter over piles that are included in the pre-installed foundation; and lowering a portion of the multi-axle transporter in order to place the liquefied gas storage tank onto the piles.

In the method, the pre-installed foundation can include piles disposed in a recess, a bottom of the liquefied gas storage tank, when disposed on the piles, is above a top of the recess, and the recess forms a region for an LNG pool in the case of a leak.

In the method, the obtaining can include installing the membrane insulation system that includes a primary membrane, primary insulation, a secondary membrane, and secondary insulation.

In the method, the obtaining can include installing the membrane insulation system on a liquefied gas side of an inner tank of the liquefied gas storage tank, and wherein a void space exists between the inner tank and an outer tank of the liquefied gas storage tank.

In the method, the obtaining can include installing strengthening members in a bottom of the liquefied gas storage tank, wherein the strengthening members are disposed at positions to carry point loads from piles of the pre-installed foundation.

The method can further include positioning a bed of a multi-axled transporter underneath the tank, wherein the tank is disposed on piles of the pre-installed foundation; and raising the bed so that the tank is lifted off of the piles.

The method can further include moving the tank to a new location for reuse or for recycling.

In the method, the liquefied gas can be liquefied natural gas.

A liquefied gas storage tank, including: a double-walled tank that stores liquefied gas, the double walls including an inner tank and an outer tank; and a membrane insulation system disposed on a liquefied gas side of the inner tank, wherein the tank is a stand-alone structure.

The liquefied gas storage tank can have a bottom that includes strengthening members, and the strengthening members can be disposed at positions to carry point loads from piles of a pre-installed foundation upon which the tank will rest.

In the liquefied gas storage tank, the membrane insulation system can include a primary membrane, primary insulation, a secondary membrane, and secondary insulation.

### BRIEF DESCRIPTION OF THE DRAWINGS

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims. It should also be understood that the drawings are not necessarily to scale, emphasis instead being placed upon clearly illustrating principles of exemplary embodiments of the present invention. Moreover, certain dimensions may be exaggerated to help visually convey such principles.

FIG. 1 depicts an exemplary method for using an LNG tank in accordance with the present technological advancement.

FIG. 2 provides an example of a membrane insulation system in a tank in an LNG ship.

FIG. 3 is an exemplary illustration of an LNG ship.

FIG. 4 is an exemplary illustration of transport using a heavy lift ship

FIG. 5 illustrates an exemplary multi-axle transporter.

FIGS. 6A, 6B, 6C, and 6D illustrates exemplary foundations.

FIG. 7 illustrates an exemplary view of LNG tank

FIG. 8 illustrates an exemplary cross-section of a structural design for an onshore modular membrane LNG tank.

FIGS. 9A and 9B illustrate differences in support between an LNG tank in a ship and a tank disposed onshore.

FIG. 10 depicts an example of the bottom support structure of an LNG tank.

FIG. 11 depicts an exemplary layout of three tanks wherein piping, electrical, and control connections are made at tank-top level.

FIG. 12 depicts an exemplary layout of three tanks wherein piping, electrical, and control connections are made at tank-top level, and the three tanks have a common berm.

FIG. 13 depicts an exemplary layout of three tanks wherein piping, electrical, and control connections are made at ground level, and the three tanks each have their own berm.

FIG. 14 depicts an exemplary arrangement were the LNG tank is disposed on concrete footings at a height above the level of an LNG pool.

### DETAILED DESCRIPTION

Exemplary embodiments are described herein. However, to the extent that the following description is specific to a particular embodiment or a particular use, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

The present technological advancement provides a new LNG storage tank and a method of using it. With the present technological advancement, for example, an LNG storage tank using a membrane insulation system can be built in a shipyard using ship building techniques at any location in the world. For example, a Q-max LNG ship may have five LNG tanks that are integral with the ship's hull. Rather than build the entire ship and these five tanks, the ship building techniques can be adapted to build just an LNG tank that embodies the present technological advancement. The tank can have an inner and outer steel structure, like the ship hull, with a membrane insulation system, pumping system, gas detection system, and vapor handling system like those on a ship. These tanks can then be transported by heavy lift ships to remote locations around the world. Once the tanks arrive at the desired location, the tanks can be moved and disposed on pre-built foundations. Then, any desired piping, electrical, and/or control system connections can be established.

The term “tank,” when used in the context of the present technological advancement, means an onshore modular membrane liquid natural gas (LNG) tank.

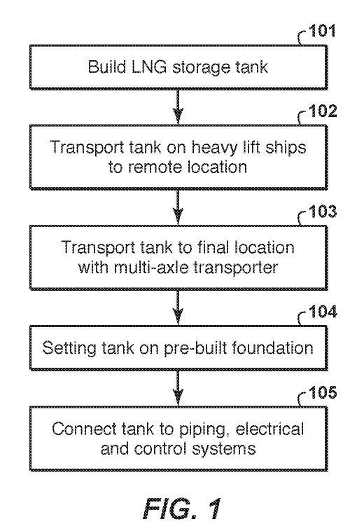

FIG. 1 provides an exemplary method for using an LNG tank in accordance with the present technological advancement. In step 101, an LNG storage tank using a membrane insulation system is built in a shipyard using shipbuilding techniques. More generally, the LNG storage tank is obtained through manufacturing or otherwise.

LNG ships use one of three LNG tank systems: membrane insulation systems, spherical systems, or self-supporting prismatic systems. Of these, the membrane insulation system is the most common. The use of membrane insulation systems for LNG tanks in LNG ships is well known and further information on such systems can be found, for example, in U.S. Pat. Nos. 7,555,991 and 7,540,395, each of which is incorporated by reference in its entirety.

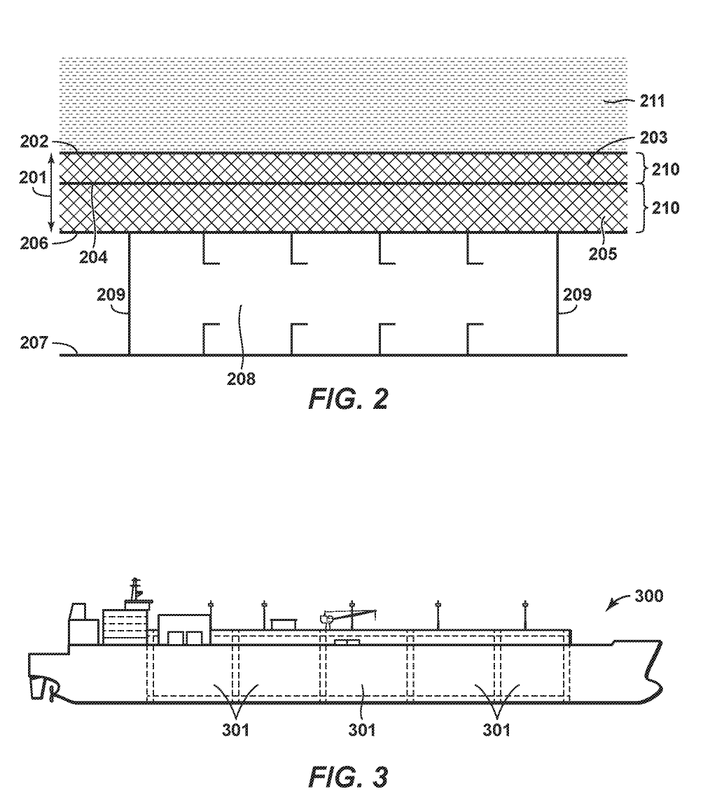

FIG. 2 provides an example of a membrane insulation system in an LNG tank. Membrane insulation system 201 includes a primary metallic membrane 202, a layer of insulation 203, a secondary membrane 204 that provides containment of the LNG 211 if the primary membrane 202 were to leak, and another layer of insulation 205. The insulation layer 205 can be connected to the inner steel hull (inner tank) 206 of the LNG tank. The space between the primary membrane 202 and the secondary membrane 204 and the space between the secondary membrane 204 and the inner steel hull 206 are called interbarrier spaces 210. The outer steel hull (outer tank) 207 of the LNG tank forms, with inner steel hull 206, a void 208. The void could be filled with a gas (air), or partially filled with an insulating material. The void can also include one or more strengthening members 209, which provide additional structural support for when the LNG tank is disposed on pile foundation, a slab foundation, or another suitable foundation. The primary membrane may be made of metals suitable for cryogenic temperatures, such as temperatures colder than −150° C. (−238° F.), e.g., colder than −160° C. (−256° F.), since the primary membrane is in direct contact with the liquefied gas contained within the tank. Cryogenic metals may include stainless steel, nickel steels, Invar (a single phase nickel alloy including about 36% weight nickel and 64% weight iron with a very low thermal expansion coefficient, such as 1.5×10⁻⁶/° C.), and the like. The secondary membrane may also be made of cryogenic metals as discussed as well as aluminum or fabric composite materials. The inner tank and outer tank may be made of non-cryogenic metals, such as carbon steel.

FIG. 3 illustrates an exemplary LNG ship 300. Ship 300 has been built as large as about 260,000 cubic meters in volume. Ship 300 typically has four or five LNG containers 301, which have been built as large as about 60,000 cubic meters in volume.

The present technological advancement employs the techniques used to build LNG ships with membrane insulation systems to build individual stand-alone LNG tanks of large size (limited by the ability to transport them) in shipyards using shipyard construction techniques. “Stand-alone” as used herein means single storage tanks, as opposed to the multiple tanks on an LNG ship, that are structurally complete and ready to set on a prepared foundation and are able to operate properly and safely with minimum connection to the onshore LNG plant. Conceptually, the present technological advancement is building one LNG tank of a LNG ship, without the rest of the ship, and solving the technical problems that arise because of the differences between a tank in an LNG ship and a tank used on land. The tank of the present technological advancement could have an inner and outer steel structure, like the ship hull, with a membrane insulation systems, pumping system, gas detection system, and vapor handling system like that on a ship. Tank sizes could range from small (say 10,000 m³) to as large as could be moved using multi-axle transporters (>100,000 m³). The present technological advancement covers tanks to as large a size as can be physically moved, and is not limited to 100,000 m³.

The steel structure of the tank would be designed for the loads it would experience in service onshore and those it would see during transport. The steel structure would have to be designed for the foundation used to support it. Such technical problems do not arise in the building of LNG containers 301 in conventional LNG ships 300.

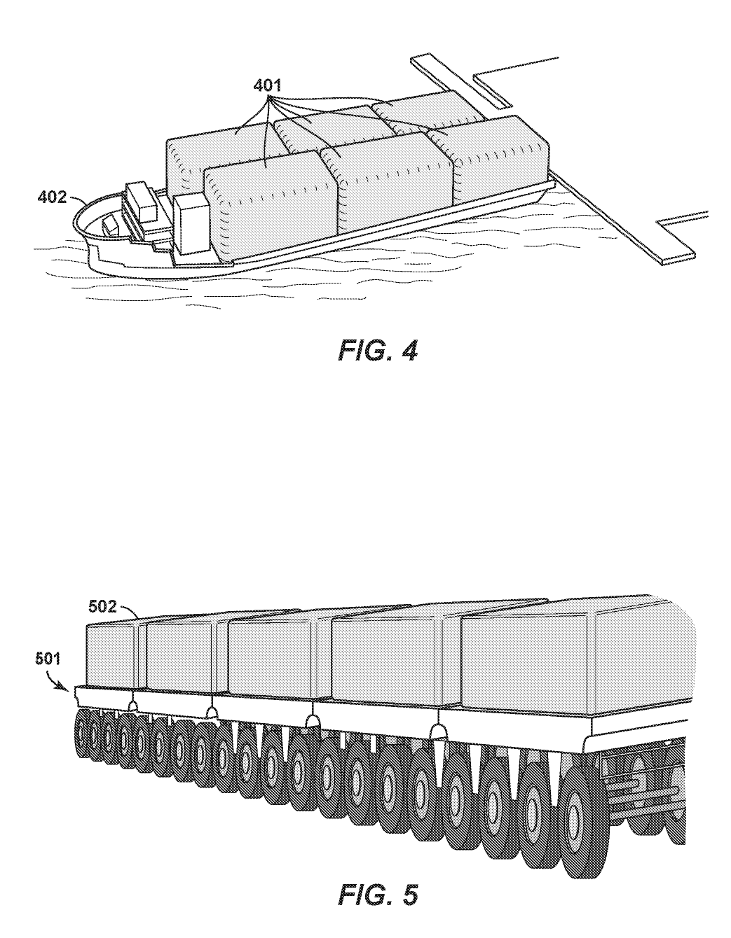

A way to support the tank would be to set it on piles that had been driven or formed at the location. This pile support would be different than the support provided to a container if it were in a ship at sea, requiring a new design for the steel structure. The tank could also be set on other foundation types. The number of piles would be determined during design. Returning to FIG. 1, step 102 includes transporting the onshore modular membrane LNG tank on heavy lift ships to a remote location. Once the tank is completely fabricated at the shipyard, it would be transported to the remote location using a heavy lift ship. These ships can transport large and heavy cargoes. FIG. 4 is an exemplary illustration of the transport of the tanks 401 using a heavy lift ship 402. Movement of large cargoes by heavy lift ship is a commercial service provided to the oil and gas industry by several vendors. Use of the heavy lift ship 402 can include fabricating the liquefied gas storage tank in a drydock, floating the liquefied gas storage tank over a partially submerged heavy lift ship, and deballasting the heavy lift ship to transit draft.

Returning to FIG. 1, step 103 includes moving the onshore modular membrane LNG tanks from the heavy lift ship to the final location. FIG. 5 illustrates an exemplary multi-axle transporter 501 carrying the onshore modular membrane LNG tanks 502. Multi-axle transporters are routinely used to move large modules in fabrication yards and to location at construction sites. As known to those of ordinary skill in the art, a multi-axle transporter (or sometimes referred to as a self-propelled modular transporter) is a platform vehicle used for transporting massive objects such as large bridge section, oil/gas equipment, motors, and other objects that are too large for or heavy for trucks.

Haul roads would have to be built from a marine berth, where the heavy lift ship docks, to the final setting location of the tank. The multi-axle transporters can be configured so that the modular membrane LNG tanks could be set over piles.

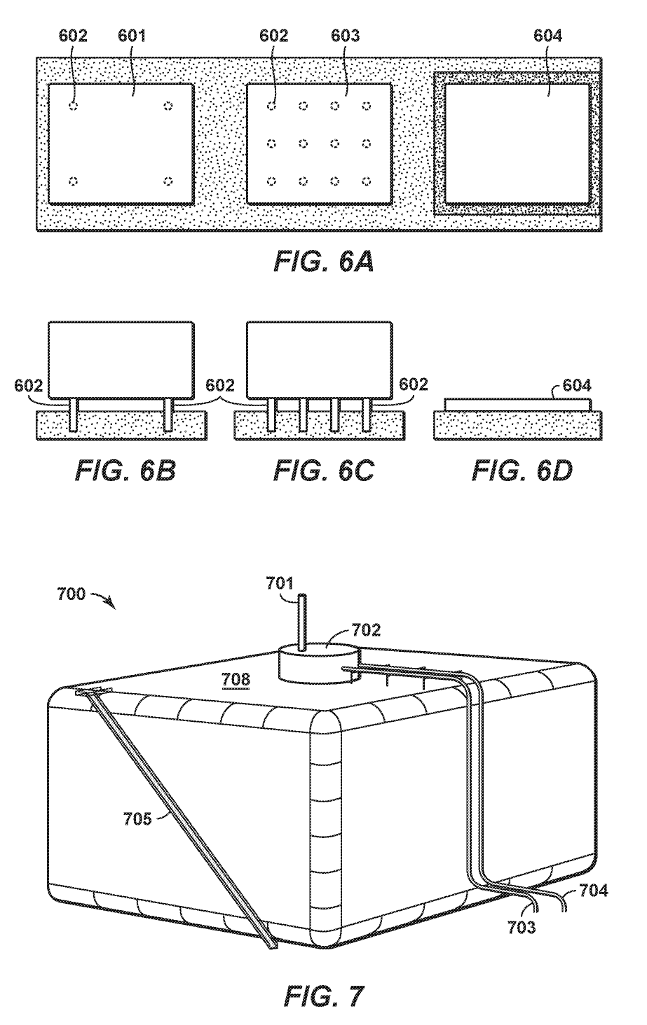

Returning to FIG. 1, step 104 includes setting the tanks on a pre-built foundation. The tanks would be moved from the heavy lift ship to pre-installed foundations at the LNG plant location. The tanks would be moved using multi-axle transporters which would move along haul roads that would have been constructed at the site. The tanks could be set on a variety of foundations as shown in FIGS. 6A-D, which illustrates exemplary foundational support structures for an onshore modular membrane LNG tank in accordance with the present technological advancement.

FIG. 6A provides a plan view of with a first foundation 601 with four piles 602. FIG. 6B provides a corresponding side view showing how LNG tank could be disposed on four piles 602. FIG. 6A provides a plan view of a second foundation 603 with 12 piles 602. FIG. 6C provides a corresponding side view showing how the LNG tank could be disposed on 12 piles 602. FIG. 6A provides a plan view of a third foundation 604, which is a slab of concrete or other suitable material. FIG. 6D provides a corresponding side view showing how LNG tank could be disposed on slab 604. The number of piles shown are for example only, the specific number and location of piles would be determined based on soil conditions and the size of the tank, and could be much larger than twelve if necessary.

When using a pile foundation, the piles can be disposed so that the multi-axle transporter would be able to drive through or around the piles (or otherwise position itself) to lower the LNG tank onto the pile foundation by adjusting the position of its bed until the weight of the LNG tank is supported by the pile foundation. Also, the multi-axle transporter could then retrieve LNG tank by positioning its bed under the LNG tank and then lifting the LNG tank off of the pile foundation and move the LNG tank to a new location for reuse or recycling. This type of transportation can reduce the cost of installing or removing the LNG tank at the LNG facility, relative to conventional LNG tanks and LNG tanks disposed on a slab foundation.

The size of the LNG tank can vary, and the present technological advancement can be scaled to tanks of various sizes. For example, the LNG tank could be 50 m in length, 45 m in breadth, 26 m in height, have a volume of 56,000 m³, an empty weight of 6,000 to 10,000 Te and a full weight of 35,000 Te. Tanks of up to 100,000 cubic meters could be transported using existing heavy lift ships and multi-axle transporters. It is possible that even larger tanks could be transported, after engineering work is done to define tank weights and the capacity of multi-axle transport systems.

Returning to FIG. 1, step 105 includes connecting the onshore modular membrane LNG tanks to piping, electrical and control systems. Once the tank is set on the pre-installed foundation, it is connected to the piping, electrical, and control systems that can be pre-installed or installed after the tank is set.

FIG. 7 illustrates an exemplary view of LNG tank 700 with additional equipment that can be connected after LNG tank 700 is disposed on its foundation. LNG tank 700 can be equipped with, among other things, a vent stack 701, tank dome 702, LNG pipe 703, vapor return pipe 704, and stairway 705 for access to the tank roof 708.

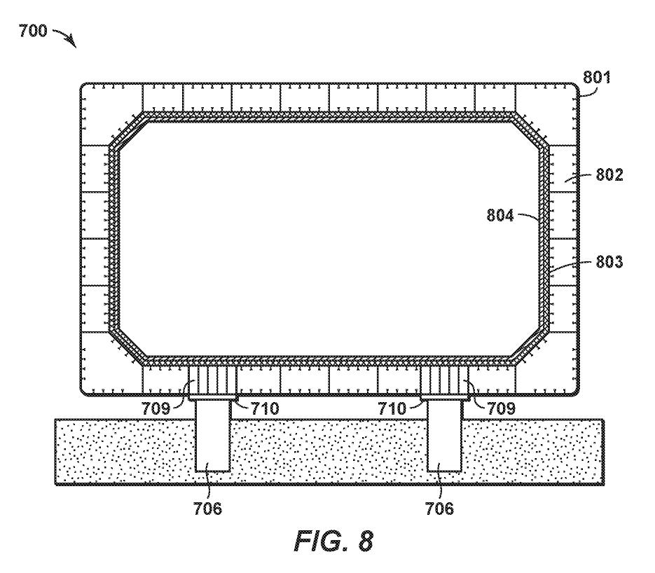

FIG. 8 illustrates a cross-section of onshore modular membrane LNG tank 700. FIG. 8 illustrates outer tank 801, void 802, inner tank 803, and membrane insulation system 804. Tanks 700 is disposed on piles 706 that form a pre-built foundation.

Membrane insulation systems on tanks in LNG ships provide containment and insulation, and are supported by the ship's hull structure. A tank in accordance with the present technological advancement, while possibly built using ship building techniques, is a stand-alone structure which not supported by a ship's hull or any other structure other than the pre-installed foundation. While FIG. 8 illustrates a two-dimensional cross section, the LNG tank 700 will be a closed structure (except for piping and venting described below) including a top, bottom, and four sides. The void can also include one or more strengthening members 709, which provide additional structural support for when the LNG tank 700 is disposed on pile foundation, a slab foundation, or another suitable foundation. The strengthening members 709 can be attached to base isolators 710, in order to protect against earth quakes in seismically sensitive areas. Isolators 710 are shown here attached to the LNG tank 700 (via strengthening members 709), but at the time of installation, the isolators 710 could be disposed on the piles of the foundation or on whatever foundation is to be used.

FIG. 8 also depicts that the corner of the inner tank 803 can be chamfered.

The membrane insulation system 804 can also include leak detection systems and methods that detect leaks of LNG through the primary and secondary membranes; pumping systems to allow for emptying the LNG tank, and venting system to handle boil-off gas.

Any associated piping and/or cabling for LNG tank 700 can be made of flexible material that would allow sufficient relative movement of the LNG tank 700 and any fixed piping during an earthquake.

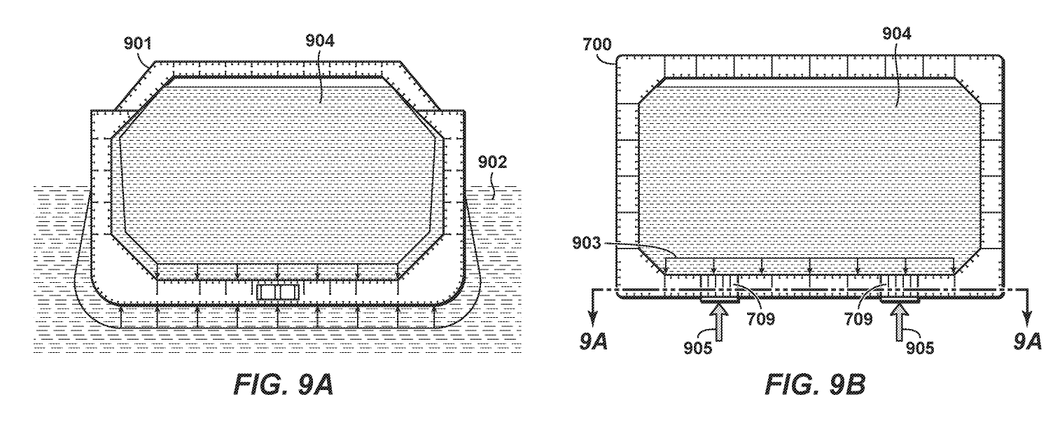

The LNG tank 700 can be designed for point supports, rather than uniform hydrostatic support that would be employed for LNG tanks on an LNG ship. LNG ship hulls 901 are supported by buoyancy from water 902, which is spread uniformly across the bottom of the ship as shown in FIG. 9A. The tank, if founded on piles, will be supported by point supports, as shown in FIG. 9B. Arrows 903 represent how the weight of the LNG 904 within the LNG tank 700 exerts pressure uniformly across the inner bottom of the LNG tank 700. Arrows 905 represent the normal force imposed on the strengthening members 709 by a pile foundation as a result of the weight of LNG tank 700 and LNG 904. The pile foundation creates point loads, which are not experienced by LNG tanks in an LNG ship.

Relative to the tanks in an LNG ship, the LNG tank 700 can have a straight or flat top as depicted in FIG. 9B, rather than crowned top deck as in the conventional tanks in an LNG ship (FIG. 9A). The straight or flat top can reduce steel and fabrication complexity.

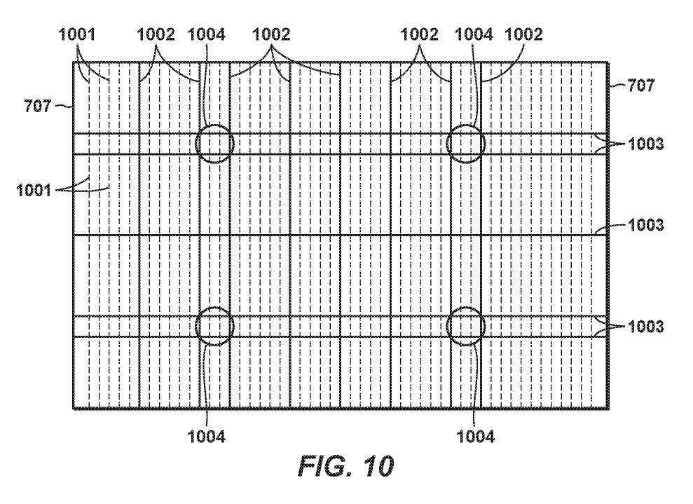

The structure of the lower part of the tank, particularly the girders and stiffeners that are between the inner and outer hulls, may need to be configured differently than that in a ship. Shipyards are well suited to design this system so that the loads can be managed while configuring the structure for fabrication using shipyard techniques. Possible changes to the internal structure between the inner and outer tanks are shown in FIG. 10.

FIG. 10 is a cross sectional view along 9A-9A (see FIG. 9B). FIG. 10 depicts an example of the bottom support structure of LNG tank 700. FIG. 10 depicts outer tank 707, longitudinal stiffeners 1001, longitudinal girders 1002, and transverse girders 1003. The circles 1004 represent where the piles would be (i.e., location of point loads). In accordance with the present technological advancement, the number and thickness of longitudinal and transverse girders can be increased relative to conventional LNG tanks, the number and/or thickness of longitudinal stiffeners can be increased relative to conventional LNG tanks, and/or the inner and outer bottom plating of the inner and outer tank can be thickened. Particularly, the transverse girders 1003 and the longitudinal girders 1002 can be disposed within the bottom support structure of LNG tank 700 at predetermined locations to coincide with the where the LNG tank 700 will rest upon the pile foundation. This can provide a means for providing enhanced structural support to handle the point loads generated by the pile foundation.

The tank may be placed in locations subject to earthquakes. Earthquake design cases will need to be added to those used for ship design, preferably using land-based tank design practices. Base isolation devices 710, well known for design of structures in earthquake areas, could be used between the piles and the tank to reduce earthquake loads on the tank.

Internal sloshing loads in partially filled LNG tanks can be important for the design of the membrane insulation system. The frequencies of earthquake loads are expected to be greater than the natural frequencies of sloshing within these tanks, limiting sloshing loads.

The tank can be designed for wind and snow loads expected at the project location.

A ship can be designed for loads from waves at sea, as are the tanks within the ships, including load cases with the tanks full of LNG. The tank can be designed for loads it may see during transport from the fabrication location to the LNG plant where is installed, but the tank will be empty of LNG for this transport case.

The tank can be designed for blast pressure loading and for resistance to projectile impact. These loads are typically defined from a project-specific risk assessment.

Thermal loading and steel temperatures for the tank will be different than those on an LNG tank in a ship. Site-specific heat transfer analyses can be used to set the tank steel design temperatures. There may be a need for tank heating, in the void space between the inner and outer tanks, in cold-weather regions.

The tank is expected to be exposed to significantly smaller fatigue loading than an LNG tank in an LNG ship. This could allow the use of design details with a lesser fatigue capacity than those on an LNG ship.

The LNG shipping industry uses mature systems for designing, fabricating, and operating the mechanical systems required to handle LNG and methane vapor in LNG tanks on ships. The design of these mechanical systems for the tank, including piping, valves, pumps, instrumentation, inert gas blanketing, pressure and vacuum relief, could be designed to be similar to those on LNG ships.

LNG pipes to fill and empty the tank and vapor lines to handle boil-off gas could be similar to those on LNG ships.

Vapor line and pressure relief valve sizes can be designed to reflect the possibility of LNG rollover (i.e., the rapid release of LNG vapors from an LNG container caused by stratification), a phenomenon that is not usually designed for on LNG ships.

Pumps and pump towers associated with the tank could be similar to those on LNG ships. Fixed or retractable pumps could be used. The tank could be trimmed, or set at a slight angle, on its foundations, with the pump and pump tower set at the lower end of the tank, to improve the ability to strip LNG from the tank. Surge/spray pumps may be installed and could be used as stripping pumps.

With respect to instrumentation, level gauges, pressure sensors, and temperature sensors can be installed.

Tanks can be equipped with systems to maintain pressures and gases in interbarrier spaces in the membrane insulation system. Systems to maintain inert gas, such as nitrogen, at pressure within the interbarrier spaces would be needed and would be like those on ships. Methane detection systems for the interbarrier spaces would be like those on ships. The void space between the inner and outer steel tanks could be filled with dehydrated air or with an inert gas such as nitrogen.

The tank can be equipped with pressure and vacuum relief valves, and could be similar to those used on ships. The specific set pressures and piping arrangements would be designed for the tank, including LNG rollover cases if required. The number, location, and piping for vents for methane release could be similar to those on ships or could be designed specifically for the site.

A firefighting system could be included in the tank mechanical systems and installed in the fabrication yard.

A heating system may be useful for heating the void space. Thermal analyses may show that heating is beneficial to keep the steel of the inner tank at an acceptable temperature. This may be particularly the case for tanks installed in Arctic regions.

The tanks can be equipped with lightning protection, aircraft warning lights, and spill protection (dip trays, spray shields, etc.).

Shipyards may be best suited to decide the fabrication method for the tank, using methods most efficient for the yard and as close as possible to shipbuilding techniques. This could include drydock fabrication:
Building outfitted and painted blocks;
Assembling the blocks in a drydock and floating the partially completed tank out of the dock;
Installing the membrane insulation and mechanical systems with tank floating at the quayside; and
Floating the competed tank onto a submerged heavy lift ship.
This could also include quay fabrication:
Building outfitted and painted blocks;
Assembling the blocks on a construction site near the quay;
Installing the membrane insulation and mechanical systems with the tank on a construction site; and
Sliding or transporting the competed tank onto a heavy lift ship.

The operations of the tank could be similar, in most regards to those on an LNG ship. Operations include commissioning, cool-down, filling and emptying of the tank, warm-up and gas freeing, and in-service inspection and repair.

Commissioning of LNG tanks in LNG ships includes an LNG gas test after the ship is completed. A volume of LNG, such as 2000 m³, is pumped into each LNG tank to cool down the tank and allow for methane leak tests. Normal tank tightness tests would be performed prior to the gas test. Methods could be developed to perform the gas test at an LNG facility near the fabrication yard or at the LNG plant site. Flexible hoses used for ship-to-ship LNG transfer could be used as part of the gas testing at an LNG facility.

Purging, cool-down, filling and emptying, and warm-up could be identical to those used for LNG ships. The need for spray nozzles for cooling could be decided on a case-specific basis.

Standard practice for LNG ships is to warm up and gas free the LNG ship tanks every five years. The LNG ship tanks are then entered for inspection, maintenance, and repair if necessary. The same operation could be performed for the tank of the present technological advancement.

Maintenance equipment, such as cranes for retrieving pumps, may be needed and could be installed at the fabrication yard.

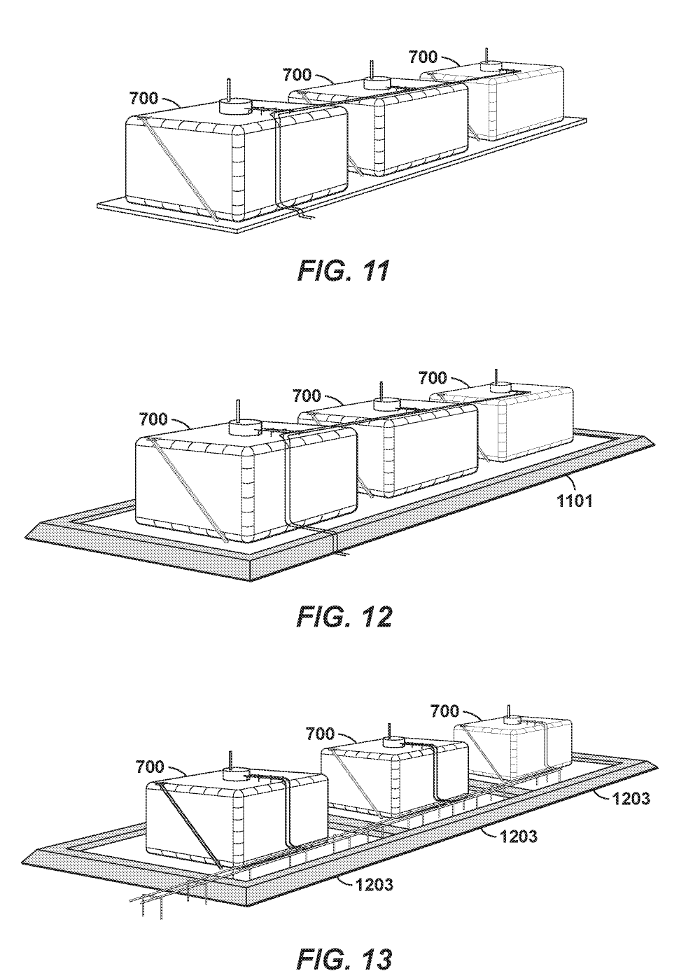

The modular tanks could be laid out in a variety of configurations at an LNG liquefaction or re-liquefaction plant. FIG. 11 illustrates an exemplary arrangement of three tanks 700, where piping, electrical, and control connection are made at tank-top level.

FIG. 12 illustrates an exemplary arrangement of three tanks 700, where piping, electrical, and control connection are made at tank-top level. The three tanks 700 can also be disposed within a common berm 1101.

Alternatively, each tank 700 could be disposed within its own berm 1201, 1202, and 1203 as depicted in FIG. 13. In FIG. 13, the three tanks 700 have piping, electrical, and control connections made at ground level. Between FIGS. 12 and 13, any combination of berms and top/ground level piping, electrical, and control connections is possible even though not every combination is depicted. Moreover, the need for a berm has not yet been established.

While FIGS. 11, 12 and 13 depict three tanks; a tank farm could include a single tank to as many tanks as would be required for the LNG plant. Large numbers of tanks could be arranged in rows in two directions, for example, a 3×4 arrangement of a total of 12 tanks.

The primary standard for the design of LNG storage tanks in LNG ships is the International Code for the Construction and Equipment of Ships Carrying Liquefied Gases in Bulk, known as the IGC Code. This is published by the International Maritime Organization. The typical standards for the design of the steel structure of ships are Classification Rules published by Classification Societies.

Standards for the design of onshore LNG tanks can include: API STD 620-11—Design and Construction of Large, Welded, Low-Pressure Storage Tanks—Eleventh Edition; Addendum 1: March 2009; API STD 2000—Venting Atmospheric and Low-Pressure Storage Tanks Nonrefrigerated and Refrigerated; ASCE 7—Minimum Design Loads for Buildings and Other Structures; NFPA 59A-2009—Standard for the Production, Storage, and Handling of Liquefied Natural Gas (LNG)—2009 Edition; and BSI BS EN 1473—Installation and Equipment for Liquefied Natural Gas—Design of Onshore Installations.

The natural periods of sloshing in a large LNG tank of the type contemplated herein would be significantly longer than the periods of earthquake ground motion acceleration. This means that it is unlikely that sloshing resonance would be excited in the tank during an earthquake so that the membrane insulation system would not be subject to excessive sloshing loads.

An alternative type of LNG tank (SPB) on LNG ships is the self-supported prismatic type, designated as a Type B tank in the IMO Gas Carrier Code. The present technological advancement could be used with the SPB system for containment and insulation of the LNG.

The top of the tank (the outer tank) could be designed with a camber to encourage drainage of rainwater, keeping it from ponding.

The tank could be used to store liquefied gases other than LNG.

The tank could be used at liquefaction plants and re-gasification plants.

Piled and slab foundations have been mentioned. Other foundation types could include gravel pads and discrete concrete footings. Pile foundations could be driven or drilled.

Discrete concrete footings could be used in locations where the soil is hard or rocky, making pile driving difficult. These could be cast-in-place, reinforced concrete footings.

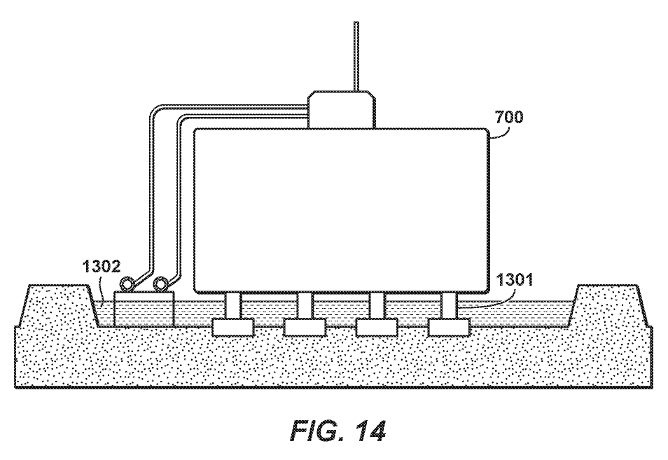

Project-specific risk assessments may identify the need to include berms to contain an accidental pool of spilled LNG. Concrete offers the advantage over steel of having some resistance to cryogenic liquids. One configuration would be to support the tank 700 on concrete footings or piles 1301 at a height above the level of LNG pool 1302 from an accidental spill, as shown in FIG. 14. Steel pile foundations could be coated in cryogenic insulation to protect the steel from LNG spills.

Foundation settlement monitoring systems can be installed and used in conjunction with the present technological advancement.

The foregoing description is directed to particular example embodiments of the present technological advancement. It will be apparent, however, to one skilled in the art, that many modifications and variations to the embodiments described herein are possible. All such modifications and variations are intended to be within the scope of the present invention, as defined in the appended claims. As will be obvious to the reader who works in the technical field, the present technological advancement is intended to be fully automated, or almost fully automated, using a computer programmed in accordance with the disclosures herein.

1. A method, comprising:
obtaining a stand-alone liquefied gas storage tank, wherein the liquefied gas storage tank includes a membrane insulation system; and
disposing the liquefied gas storage tank onto a pre-installed foundation.

2. The method of claim 1, further comprising:
transporting the liquefied gas storage tank using a heavy lift ship;
transporting the liquefied gas storage tank using a land-based transportation system; and
connecting the liquefied gas storage tank to piping, electrical, and control systems.

3. The method of claim 2, wherein the pre-installed foundation is a piled foundation.

4. The method of claim 2, wherein the pre-installed foundation is a slab foundation, a gravel pad, or concrete footings.

5. The method of claim 2, further comprising:
fabricating the liquefied gas storage tank in a drydock;
floating the liquefied gas storage tank over a partially submerged heavy lift ship; and
deballasting the heavy lift ship to transit draft.

6. The method of claim 2, further comprising fabricating the liquefied gas storage tank on a quay and moving the liquefied gas storage tank onto a heavy ship.

7. The method of claim 2, further comprising disposing base isolation devices between the foundation and the liquefied gas storage tank to minimize earthquake loads on the liquefied gas storage tank.

8. The method of claim 2, further comprising creating a tank farm by disposing a plurality of stand-alone liquefied gas storage tanks at a liquefaction plant, regasification plant, or a peak-shaving plant.

9. The method of claim 2, further comprising establishing a berm around the liquefied gas storage tank.

10. The method of claim 3, further comprising:
positioning the liquefied gas storage tank using a multi-axle transporter over piles that are included in the pre-installed foundation; and
lowering a portion of the multi-axle transporter in order to place the liquefied gas storage tank onto the piles.

11. The method of claim 3, wherein the pre-installed foundation includes piles disposed in a recess, a bottom of the liquefied gas storage tank, when disposed on the piles, is above a top of the recess, and the recess forms a region for an LNG pool.

12. The method of claim 1, wherein the obtaining includes installing the membrane insulation system that includes a primary membrane, primary insulation, a secondary membrane, and secondary insulation.

13. The method of claim 1, wherein the obtaining includes installing the membrane insulation system on a liquefied gas side of an inner tank of the liquefied gas storage tank, and wherein a void space exists between the inner tank and an outer tank of the liquefied gas storage tank.

14. The method of claim 1, wherein the obtaining includes installing strengthening members in a bottom of the liquefied gas storage tank, wherein the strengthening members are disposed at positions to carry point loads from piles of the pre-installed foundation.

15. The method of claim 3, further comprising:
positioning a bed of a multi-axled transporter underneath the tank, wherein the tank is disposed on piles of the pre-installed foundation; and
raising the bed so that the tank is lifted off of the piles.

16. The method of claim 15, further comprising:
moving the tank to a new location for reuse or for recycling.

17. The method of claim 2, wherein the liquefied gas is liquefied natural gas.

18. A liquefied gas storage tank, comprising:
a double-walled tank that stores liquefied gas, the double walls including an inner tank and an outer tank; and
a membrane insulation system disposed on a liquefied gas side of the inner tank,
wherein the tank is a stand-alone structure.

19. The liquefied gas storage tank of claim 18, wherein a bottom of the tank includes strengthening members, wherein the strengthening members are disposed at positions to carry point loads from piles of a pre-installed foundation upon which the tank will rest.

20. The liquefied gas storage tank of claim 18, wherein the membrane insulation system includes a primary membrane, primary insulation, a secondary membrane, and secondary insulation.
